(19) United States
(12) Patent Application Publication
(10) Pub. No.: US 2012/0131151 A1
(43) Pub. Date: May 24, 2012

(54) LOCATOR AND MESSAGING SYSTEMS, METHODS AND APPARATUS

(76) Inventor: Xinkai WANG, Bellevue, WA (US)

(21) Appl. No.: 13/301,687

(22) Filed: Nov. 21, 2011

Related U.S. Application Data
(60) Provisional application No. 61/458,210, filed on Nov. 19, 2010.

(51) Int. Cl. G06F 15/16

(52) U.S. Cl. 709/219

(57) ABSTRACT

Methods, graphical user interfaces, systems and devices for remotely tracking location of a subject, such as a child, and for remotely communicating with the subject. The devices can be low cost, low function devices, having limited input members, which can be used for encoding a small set of frequently-used messages. In some embodiments, the low function devices do not have display screens, but can receive messages by generating vibration pulses using a vibration motor.

### CROSS-REFERENCE TO RELATED APPLICATION(S)

This application claims the benefit of U.S. provisional patent application Ser. No. 61/458,210, filed Nov. 19, 2010, which is incorporated herein by reference in its entirety.

### BACKGROUND

1. Technical Field

The following disclosure relates to methods, systems and devices for use in location tracking and messaging.

2. Description of Related Art

Current personal tracker devices typically rely on GPS and GSM communication. The devices can be small, typically weighting 2-3 ounces, and use a GPS receiver to determine current geographic coordinates of its location (presumably the location of a “subject,” such as, for example, a child being tracked by a parent). The personal tracker can also be configured to use a GSM network or Wi-Fi (such as A-GPS technology). In some devices, the personal trackers send their geographic coordinates received from GPS to dedicated servers via the GSM. Thereafter, the location information can be accessed remotely by users through the Internet, via stationary or portable communication devices (e.g., computers or cell phones). The communication devices can execute software applications to provide graphical user interfaces for accessing the information or can simply access web-based software, such as software hosted on the dedicated server, to view the location information.

Some personal tracker systems also allow users to perform some administrative operations, such as, for example, to send instructions to the remote tracking device to start or stop reporting location, to set the reporting interval, or to check battery status, etc.

Currently, most GPS/GSM personal tracking systems use GPRS/EDGE or 3G/4G to communicate with the server. Other personal tracking systems can use SMS to send out location reports. The typical personal tracking systems have a GSM/GPRS (or 3G/4G module and microcontroller, and some are capable of receiving a SIM card, to function similar to a simple cell phone device. Some differences between such personal trackers and cell phones include that the personal trackers do not require a display screen, keyboard, speaker or microphone (although some personal trackers do include a microphone for one way audio monitoring of the subject).

In addition, some personal tracker devices have limited communication capabilities that can be activated by the subject, such as, for example, a panic button, “SOS button,” or “call for help button,” (also all referred to herein collectively as, “panic button”). In some of these devices, if a panic button is pressed for a particular time frame (e.g., more than 2 seconds), the personal tracker device notifies the users, including via sending a signal to the server or via SMS report. The user (e.g., a parent) can then view the panic button status, and access information regarding the location of the subject (e.g., child).

The existing personal tracker systems, although simple, have insufficient flexibility to convey information that may sometimes be critical for a user to determine such things as whether an emergency situation has been conveyed, and if so, the severity of the emergency. Such information can impact the action taken by a user receiving the information, such as a parent. The existing personal tracker systems also typically lack two way communication capability to allow users to send information to the subject, in addition to receiving information from the subject. That is, the low cost simplicity of the typical personal trackers, although beneficial in one sense, limit the communication capabilities of the personal trackers in another sense.

### BRIEF SUMMARY OF THE DISCLOSURE

Various embodiments of the present disclosure include a remote device for use in tracking location of subject and transmitting messages. The remote device can include a GPS module, at least one input member usable for generating a signal of recordable duration as a function of depression duration of the input member, a processor operable for encoding a signal sequence as a function of a number of depressions and the duration of each depression, a transmitter for use in wirelessly transmitting the signal sequence and for transmitting location information provided by the GPS module and a receiver for use in wirelessly receiving a signal from a remote transmitter. The signal received can include a sequence of pulses and the processor can be operable for decoding the signal containing the sequence of pulses and for communicating the sequence of pulses to the subject. Systems and methods for using or employing various embodiments of the remote device are also disclosed herein.

### BRIEF DESCRIPTION OF SEVERAL VIEWS OF THE DRAWINGS

FIG. 1 is a simplified diagram showing a remote device or personal tracker for some embodiments of the present disclosure.

FIG. 2 is a block diagram illustrating various components of the remote device of FIG. 1.

FIG. 3 is a simplified diagram showing a tracking and message system of the present disclosure.

### DETAILED DESCRIPTION

In the following description, certain specific details are set forth in order to provide a thorough understanding of various embodiments of the disclosure. However, upon reviewing this disclosure one skilled in the art will understand that the disclosure may be practiced without many of these details. In other instances, well-known structures, systems and methods associated with wireless devices and networks, have not been described in detail to avoid unnecessarily obscuring the descriptions of the embodiments of the disclosure.

Throughout various portions of the following description, the embodiments of the present disclosure are described in the context of communication between a parent and child, or a care giver and a care receiver, wherein the latter party is in possession of the remote device. However, as will be understood by one skilled in the art after reviewing this disclosure, various embodiments of the present disclosure may have a wide variety of applications in other contexts (and fields) such as, for example, wherein the remote device is used by workers in a variety of industrial settings, either as a backup communication device, or a primary communication device. In such contexts, the remote device could be compact and small, such as to be portable on a wrist watch or bracelet, to provide quick and compact access to communication in situations where limited communications are needed, and/or wherein an environment is noisy or inconvenient for using a cell phone, or even unsafe, to be distracted by the functions required to use a cell phone or other more complicated communication device.

The descriptions of examples of the present disclosure provided herein are not intended to be restrictive unless otherwise indicated. The drawings include example information depicted for illustrative purposes. Also, various examples set forth below describe a host server 4 usable for processing and/or storing information received from the remote device 1 to be accessible by a user, or for sending information to the remote device 4. However, as will be appreciated by those skilled in the art upon reviewing this disclosure, multiple host servers 4 may be used to provide aggregate processing capacity and storage capacity, either in parallel or in a distributed computing context. Furthermore, in some embodiments, software application components of the present invention may be stored on a user computer, or wireless device (e.g., cell phone) to execute various tasks associated with the embodiments of the present disclosure, either entirely, or in conjunction with one or more applications residing on the host server 4, as will be appreciated by those skilled in the art after reviewing this disclosure. Various features provided by the present disclosure are described herein in the context of interaction with a user cell phone or other data device, however, some or all of those features may be accessed by the user via any wireless communication device or via a hard wired computer having access to the Internet. Various communications described herein between the remote device 2 and computer, cell phone or data device of the user, utilize a central server 4. However, in some embodiments, the server 4 is not necessary and direct communication may be established between the remote devices 2 and user device (e.g., cell phone) via a cellular network, as will be appreciated by those skilled in the art after reviewing this disclosure. Also, the remote device may transmit messages via SMS, including location updates.

In the present description, the term “about” or “consisting essentially of” mean ±20% of the indicated range, value, or structure, unless otherwise indicated. It should be understood that the terms “a” and “an” as used herein refer to “one or more” of the enumerated components. The use of the alternative (e.g., “or”) should be understood to mean either one, both, or any combination thereof of the alternatives. As used herein, the terms “include” and “comprise” are used synonymously, which terms and variants thereof are intended to be construed as non-limiting.

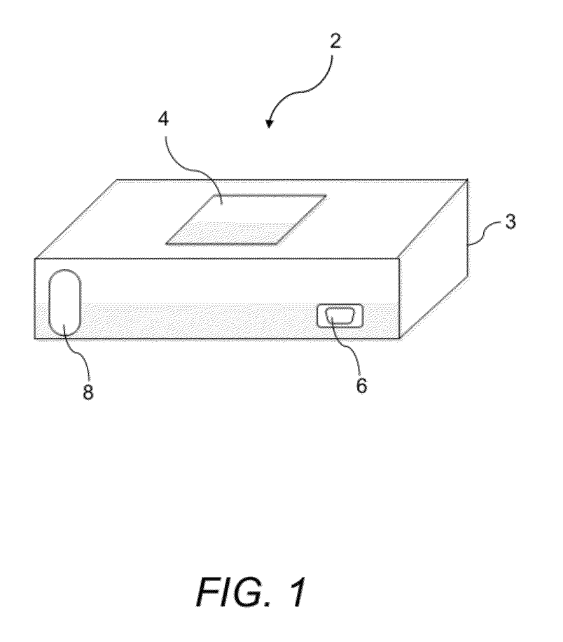

Referring to FIG. 1, in some embodiments of the present disclosure, a remote device 2, having a case 3, can be a personal tracker or communication device. The remote device 2 can have a message button, or input member 4, which may be a single input member 4. Also, the remote device 2 may be chargeable through a power coupling inlet 6, which can be, for example, a USB charge port. The remote device 2 can also be provided with a power button 8, which can be connected to an internal switch to turn power “on” or “off” to the remote device 2.

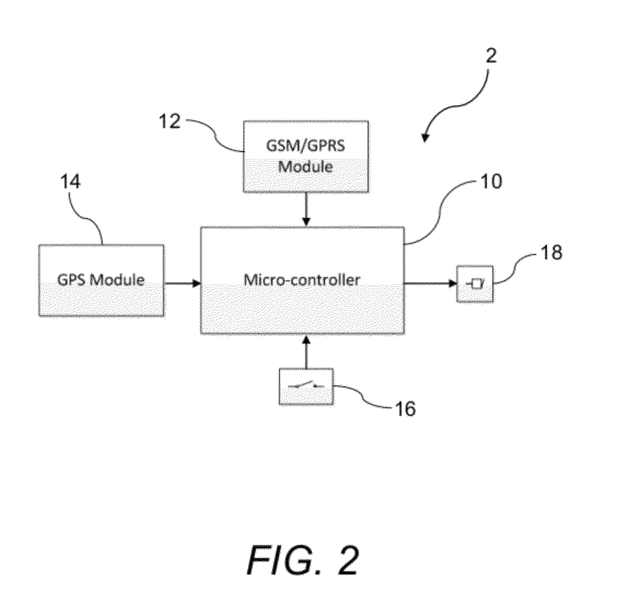

Referring to FIG. 2, in some embodiments, the remote device 2 can also comprise a microcontroller 10, which can have a memory and processor, capable of receiving input from a network communication module 12, such as, for example, a GSM/GPRS module. The microcontroller 10 is also capable of receiving input from a message switch 16, which can be actuated by depression of the input member 4 (shown in FIG. 1). A global positioning system (GPS) module 14 can also be communicatively connected to the microcontroller 10 for receiving location information regarding the remote device. Also, the microcontroller 10 can control a vibration motor 18, such as, for example, a vibration motor with offset mass or weight, like those commonly found in cell phones, as will be appreciated by those skilled in the art after reviewing this disclosure.

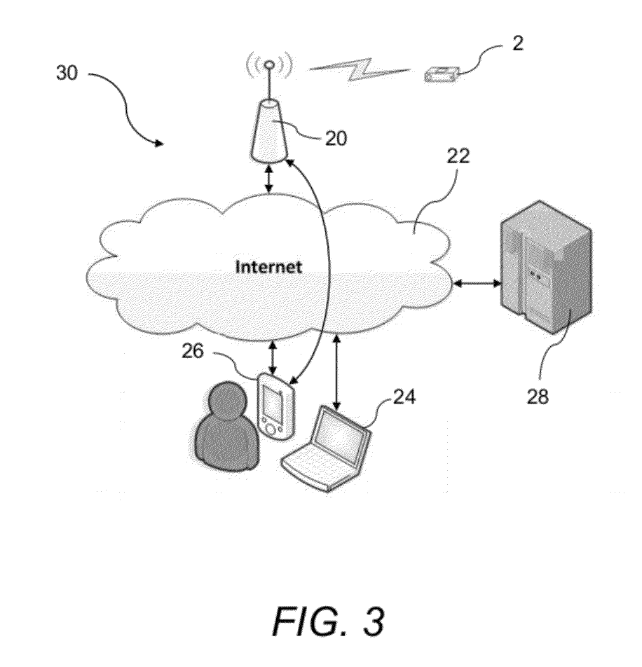

Referring to FIG. 3, the remote device 2 can be part of a system 30 including a cellular data network 20, such as, for example, a GPRS/EDGE network, over which the remote device 2 can transmit information to the Internet. Alternatively, the network can be EDGE/3G/4G (or even Wi-Fi). In addition, one or more servers 28 are communicatively coupled to the Internet, and in turn communicatively linked to the remote device 2 through the cellular data network 20.

In some embodiments, a user (e.g., parent) device, such as a cell phone 26, can be communicatively coupled to the Internet, either directly or indirectly through a cellular data network 20, and then in turn, communicatively coupled to the server 28. A user computer 24 may also be directly connected to the Internet and thus communicatively linked to the server 28.

In some embodiments of the present invention, the GPS module 14 of the remote device 2 will send location information to the server 28, on periodic bases, the length of time between such transmissions being pre-designated within microcontroller 10, or being adjustable by a user. A user may remotely adjust these time periods. That is, for example, in some embodiments, a graphical user interface accessible by the user via the cell phone 26 or computer 24, may provide indicia for selecting and setting transmission intervals of the remote device 2 related to location information, among other things, as will be appreciated by those skilled in the art.

A subject can actuate (e.g., “close”) the message switch 16 by depressing (e.g., pressing downward) the input member 4. When the subject reduces manual pressure on the message switch, the switch can open. In some embodiments, the message generated by depressing the input member 4 can be a code that is a function of the number of times the input member 4 is depressed, and the duration of each depression. The depression sequence coding can be, for example, a long-short coding method. In a long short coding method, a processor in the remote device can record depressions as, for example, “long short long,” or “long long long” or “short, long short,” etc., or any of various combinations of duration and number of depressions. In some embodiments, the duration of a “long” or “short” depression can be pre-set within the processor 10 (or microcontroller). For example, without limitation, a short depression can be anything less than one second, and a long depression can be anything greater than or equal to one second. Also, any absence of depression for more than five (5) second can signal end of a message. As such, in one example, input member 4 activity could be encoded within the microcontroller 10 according to the following conditions:

depression<1 second=short;

depression≦1 second=long;

No activity≦5 seconds=end message.

In other embodiments, a run-length coding method can be used. That is, for example, the activity of the input member can be recorded with higher-fidelity, which can involved, using run-length encoding to record the duration of each pulse (the “on” time), and also the time between each pulse (the “off” time). For example, is a subject presses the input member 4 and holds it for 1.0 seconds, waits 0.5 second after releasing it, then presses the input member again for another 0.4 second, the result of the run-length coding (with 1 millisecond resolution) would be an array of integer: [1000, 500, 400]. In the results array, the odd numbers represent the “on” time, and the even numbers represents the “off” time. When there are N pulses in a “message”, the run-length coding results array size is 2N−1. In some embodiments here, any absence of depression for more than five (5) second can signal end of a message. In practice, after establishing this array of integers, one could also employ other encoding methods like Dynamic Quantization (DQ), Huffman coding, or other entropy compression algorithms to reduce the data size needed to store and transmit the message.

In some cases, the encoded depression sequence can then be transmitted by the remote device 2 to the server 28 to parse, or otherwise process, into a grammatical structure. In some embodiments, the microcontroller or processor 10 of the remote device only encodes the sequence for the server (e.g., using run-length encoding or other encoding algorithms). For example, the server 28 could interpret the encoded depression sequence based on predetermined settings, or based on settings agreed upon between the user (e.g., parent) and subject (e.g., child). In some embodiments, the long-short coding method could take place in the server 4, or in an application otherwise residing on a user computer device, after receiving a high-fidelity recording of the encoded depression sequence, for use in interpreting the sequence.

As a prophetic example, the child and parent could agree that a depression sequence of “short, short, long,” could signal, “I'm lost,” a sequence of “short, long, short,” could signal “I'm ok,” and a sequence of “long, long, long,” could signal “help quick.” The grammatical interpretation of the depression sequences can be selected by a user using a web based interface hosted on the server 4, or an application hosted on the user's cell phone device or computer. When the depression sequence is interpreted, it can be transmitted from the server to the user by display of plain text containing the message. In other embodiments, the depression sequence itself can be transmitted to the user by tones, or by vibrating the cell phone or data device of the user in the same sequence as the depression sequence. Alternatively, a graphical representation of the depression pulse sequence can be displayed to the user on the user computer or cell phone (or data device).

In some embodiments, the encoded depression sequences may also be transmitted directly to the user's cell phone via the cellular network, and be interpreted using an application residing on the cell phone, and may be displayed as graphical representations of the sequences (e.g., by graphical indicia having size or length proportional to the length of the depression sequences), or may be displayed as conventional grammatical messages as interpreted by a cell phone application. Alternatively, the encoded depression sequences could be transmitted as tone sequences audible on the user's cell phone, or vibration sequences that can be pulsed on the user's cell phone having a vibration motor.

Also, in some embodiments, there could be additional duration conditions in which a longer duration of input member 4 depression could signal “panic,” instead of a sequence of depressions, such as, for example, depressing and holding the input member 4 for more than 2-5 seconds. Also, in further embodiments, such longer term depression of the input member 4 could be interpreted as “extra long,” depressions by microcontroller 10. That is, for example, any depression in a sequence lasting longer than 3 seconds could be encoded as an “extra long” depression within the sequence, to add additional messaging capability if the subject is sufficiently sophisticated to execute it. For example, if the user wants certainty before taking drastic actions like contacting authorities, etc., the user may require that a certain sequence of depressions less likely to be accidentally triggered, be executed. One such sequence might be “extra long, extra long, extra long,” to signal high level emergency.

In further embodiments, the duration of depression required is adjustable by a user (e.g. parent), either through a web based interface on server 4 that is communicatively linked to the remote device 2, or through an application residing on the user's data device (e.g., cell phone or computer).

In further embodiments of the present invention, a user (e.g., parent or care giver), can send messages to remote device's 2 to signal the subject by activating the vibration motor 18. In some embodiments, the vibration motor can vibrate in sequences depending on an agreed upon code between the subject and user. That is, the duration of each vibration pulse, and the space between the pulses, strung together in sequence can signify certain messages, if such sequences are memorized by the subject. Alternatively, or in conjunction with, such sequences, the user can simply signal an acknowledgement of the subject's message by sending a single vibration pulse, so that the subject knows that, for example, “help is on its way.”

In some embodiments, the vibration motor 18 of the remote device 2 can be substituted with, or supplemented with, other pulse signal conveying elements, such as, for example, an LED light, or sound buzzer, etc. As such, the vibration pulses can be simultaneously or alternatively conveyed by light or sound to the remote device user.

The user can access the graphical user interface (as discussed above) to access a control page for initiating vibration pulses at the remote device 2. In some embodiments, the vibration pulse sequences have been pre-set in relation to certain messages that a user can select from a graphical user interface. For example, “stay where you are,” could be a sequences of pulses consisting or comprising of a long, short, long, with a stop (non-pulse period) between each vibration pulse. “Come home now!” could be another sequences of pulses, consisting or comprising of a short, short, short sequence, with a stop between each pulse. These are non-limiting examples of messages agreed upon between the subject and the user. In the graphical user interface (not illustrated), a user could select a message list, then select (e.g., mouse click) on the message, which could then be transmitted to the subject by being encoded in a vibration pulse sequence. Alternatively, the user could key in a specific vibration pulse sequence to the subject in a particular graphical user interface, such that the vibration pulse sequence at the remote device, matches the user's keying sequence on a computer or cell phone, etc., as controlled by an application. In such manner, the present disclosure provides, among other things, a low cost, simple and quick method of establishing two-way communication.

In some embodiments of the present invention, a user may select to group a plurality of remote devices 2 into one virtual talking group, which can be accomplished by application on the server 4, so that any message sent by one device is received by all devices and users in the group. This provides a convenient way for members of the group to communicate and has advantages over some conventional group communication devices (e.g., FM/AM walkie-talkies). The advantages include that the remote devices 2 are light weight and small, and that there is no distance limitation. A service plan for such communication devices can also be low cost.

Although the remote device 2 is illustrated and described above as having only a single input member 4, in some embodiments of the present disclosure, multiple input members (e.g., message buttons) may be included on the remote device 2. The different input members can represent different signals so as to provide more flexibility for communication purposes. The parameter of duration of the depression could be, for example, substituted by the identity of the key, such that the subject selects which key to press, instead of how long to press the key, as part of the depression sequence. Thus the depression sequence could be, for example, without limitation, button 1, button 2, button 3, then pause, which may be parsed at the server 4 (or elsewhere) to indicate “Mommy, I'm lost,” or button 2, button 2, button 3, which may be parsed to indicate “I need help now.” Also, each different message button could represent a different frequency tone to transmit for receipt by the user's device, and the combination of tones and number of tones can represent specific messages. Alternatively, various message buttons could initiate stand alone complete messages.

In various embodiments of the present invention, the pulse based coding can utilize Morse code for parsing or generating a message based on the code, as will be appreciated by those skilled in the art after reviewing this disclosure.

Although specific embodiments and examples of the disclosure have been described supra for illustrative purposes, various equivalent modifications can be made without departing from the spirit and scope of the disclosure, as will be recognized by those skilled in the relevant art after reviewing the present disclosure. The various embodiments described can be combined to provide further embodiments. The described systems, graphical user interfaces, devices and methods can omit some elements or acts, can add other elements or acts, or can combine the elements or execute the acts in a different order than that illustrated, to achieve various advantages of the disclosure. These and other changes can be made to the disclosure in light of the above detailed description.

In general, in the following claims, the terms used should not be construed to limit the disclosure to the specific embodiments disclosed in the specification.

What is claimed is:

1. A remote device for use in tracking location of subject and transmitting messages comprising:
a GPS module;
at least one input member usable for generating a signal of recordable duration as a function of depression duration of the input member;
a processor operable for encoding a signal sequence as a function of a number of depressions and the duration of each depression;
a transmitter for use in wirelessly transmitting the signal sequence and for transmitting location information provided by the GPS module; and
a receiver for use in wirelessly receiving a signal from a remote transmitter including a sequence of pulses and wherein the processor is operable for decoding the signal containing the sequence of pulses and for communicating the sequence of pulses to the subject.

2. The remote device of claim 1 wherein the remote device does not include a display screen.

3. The remote device of claim 2 comprising a plurality of input members, each input member capable of initiating a unique signal to the processor.

4. The remote device of claim 1 further comprising a vibration motor for generating vibration pulse sequences to communicate the sequence of pulses.

5. The remote device of claim 1 wherein the processor interprets the depression duration of the input member as only a first duration or a second duration, depending on whether the depression duration is less than, or greater than, a pre-defined duration.

6. The remote device of claim 5 wherein the processor can also interpret the depression duration of the input member as a third duration, depending on whether the depression duration is equal to or greater than a second pre-defined duration representing a panic message.

7. A computer implemented method of communicating between a subject and user comprising:
receiving a signal sequence from a remote device possessed by a subject, having at least one input member and no display device, the signal sequence being generated based on a plurality of depressions of an input member made by the subject, the signal sequence being a function of duration of the depressions;
interpreting the signal sequence to represent the signal sequence to a user; and
sending a signal sequence to the remote device to generate a pulse or sequence of pulses on the remote device.

8. The computer implemented method of claim 7 wherein representing the signal sequence to the user comprises displaying a grammatical message indicating a condition or request of the subject.

9. The computer implemented method of claim 7 wherein representing the signal sequence to the user comprises actuating a sequence of vibration pulses on a cell phone.

10. The computer implemented method of claim 7 wherein representing the signal sequence to the user comprises displaying a graphical representation of the depressions including duration of the depressions and the time between the depressions.

11. The computer implemented method of claim 7 wherein representing the signal sequence to the user comprises actuating a sequence of lighting pulses on a cell phone of the user indicating a condition or request of the subject.

12. The computer implemented method of claim 7 wherein representing the signal sequence to the user comprises actuating a sequence of tones on a cell phone of the user indicating a condition or request of the subject.

13. The computer implemented method of claim 7 further comprising receiving location information regarding the subject transmitted from a GPS module of the remote device.

14. The computer implemented method of claim 7 wherein signals are received from a plurality of remote devices possessed by a plurality of subjects.

15. The computer implemented method of claim 7 further comprising adjusting the interpretation of the signal sequence based on user settings.

16. The computer implemented method of claim 15 wherein the user settings associate specific grammatical messages with specific signal sequences, the grammatical messages being selected by the user.

17. A system for communicating between a subject and user, the system comprising:
a remote device having at least one input member and at least one vibration motor, lighting device or tone generator, the remote device not having a display screen;
a processor of the remote device capable of storing signal sequences as a function of depression durations depression of the input member;
a transmitter of the remote device for wirelessly transmitting the signal sequences; and
a processor of a computing device, communicatively linked to the remote device, and configured for interpreting the signal sequences and representing the signal sequences to a user.

18. The system of claim 17 wherein the remote device further comprises a GPS module for use in collection location information for a subject in possession of the remote device and for transmitting the location information to the computer device.

19. The system of claim 17 wherein the computing device is operable for use in initiating a pulse or pulse sequence of vibration motor, lighting device or tone generator.

20. The system of claim 17 wherein the interpretation of the signal sequences is pre-defined by a user of the computing device, such that particular signal sequences can be associated with particular messages displayable to the user.
